(19) United States
(12) Patent Application Publication
(10) Pub. No.: US 2006/0112142 A1
(43) Pub. Date: May 25, 2006

(54) Document retrieval method and apparatus using image contents

(76) Inventors: Hiroshi Sako, Shiki (JP); Atsushi Hiroike, Kawagoe (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/205,198

(22) Filed: Aug. 17, 2005

(30) Foreign Application Priority Data
Nov. 22, 2004 (JP) 2004-336860

(51) Int. Cl. G06F 17/00

(52) U.S. Cl. 707/104.1

(57) ABSTRACT

A document retrieval method replaces a document with images capable of providing at-a-glance views. Image such as photographs, drawings and tables contained in a document are used as index images for the document. A query formulation formed with one or more of the key images are entered, and all the images in the document which contains similar images satisfying the query formulation are three-dimensionally displayed on a display screen. Upon a searcher selecting one of the displayed images, contents of the document containing the selected image are displayed.

### CLAIM OF PRIORITY

The present application claims priority from Japanese application JP 2004-336860 filed on Nov. 22, 2004, the content of which is hereby incorporated by reference into this application.

### FIELD OF THE INVENTION

The present invention relates to a method and apparatus for retrieving documents using images contained in the documents. The term “documents” used herein include Website documents available on the World Wide Web (WWW). The present invention particularly relates a method and apparatus for efficiently retrieving such documents. The term “images” used herein refers to various images appearing in documents, including photographs, drawings, diagrams, tables, graphs, and symbols.

### BACKGROUND OF THE INVENTION

In specific fields, such as patents and medicine, it has long been indispensable to retrieve previous documents for examining the novelty of inventions or studying similar cases. Therefore, the retrieval technology has been actively studied and developed in these fields. On the other hand, recent improvement in infrastructure such as communication networks has established a basis for developing search and retrieval technologies and software which enable individuals to obtain desired information from the Internet or intranet. A majority of these search and retrieval technologies are based on the assumption that keywords are recorded in advance. Specifically, plural keywords are previously extracted from a document text or a keyword is extracted from a title of an image in a document, and these keywords and documents are recorded in association with each other. When retrieved, a document which seems to be similar to a keyword given by a user query is extracted by using the correspondence relationship in the record (Japanese Patent Laid-Open Publication No. 2000-067066 titled “Document Image Management Method, Document Image Retrieval Method, Document Image Management System, and Storage Medium”).

According to the document retrieval methods as described above, typically, similarity measurements are computed based on frequency of detection of plural keywords to, and document titles or URLs of Website documents thus retrieved are displayed in the order of the similarity measurements. In this case, the searcher is required to open the document files one by one to check the contents thereof, and it is very troublesome to do that. In other words, the conventional document retrieval methods require the searcher to examine each document to decide on the relevance of the documents, and it is difficult to provide the search results in an at-a-glance fashion. As an attempt to solve this problem, Japanese Patent Laid-Open Publication No. H5-216936A titled “Document Collection and Retrieval Method”, for example, proposes a method in which outline images showing outlines of documents are recorded in advance, and an outline image of the document which matches searching conditions given in character information (keyword) is displayed. This method eliminates the trouble of reading the retrieved documents to check the relevance, and thus improves the retrieval efficiency.

On the other hand, there have also been proposed image retrieval methods, such as a method of manually assigning a keyword to each image, and a method of extracting features such as colors or shapes from each image to conduct search based on these features.

As described above, according to the conventional document retrieval methods, typically, the similarity measurements are computed based on the frequency of detection of plural keywords, and titles of documents or URLs of Website documents retrieved are displayed in the order of the similarity measurements thus obtained. In this case, the searcher is required to open the document files one by one to check the contents thereof, and it is very troublesome to do that. In other words, the conventional document retrieval methods require the searcher to examine each document to decide on the relevance of the documents, and it is difficult to provide the search results in an at-a-glance fashion. Although there has been proposed a method, as described in JP H5-216936A, to generate and record outline images in advance, it takes a lot of time and costs a lot of money to implement this method. It is also difficult to display outline images of all the documents retrieved on a monitor screen at a time. Thus, it cannot be said that this conventional method has solved the outstanding problems completely. Moreover, the use of natural language keywords is not sufficient to retrieve desired documents efficiently. This is because it is rather difficult to precisely match a query against contents of documents based only on the frequency of appearance of the keywords in the documents, and a retrieval result thus obtained is not always formed of relevant documents only.

### SUMMARY OF THE INVENTION

In order to solve the problems as described above, a document retrieval method according to the present invention replaces a document with images capable of providing at-a-glance views. Specifically, images such as photographs, drawings and tables contained in a document are used as key images for the document. A query formulation using one or more of the key images is entered, and all of the images in the documents which contain relevant images satisfying the query formulation are three-dimensionally displayed on a display screen. Upon a searcher selecting one of the displayed images, contents of the document containing the selected image are displayed.

More specifically, one aspect of present invention is a document retrieval method for retrieving a document containing images, and the method includes: a first step of mapping document data to index image data contained in the corresponding documents; a second step of selecting a specific image as a key image; a third step of forming a query formulation with the use of the selected key image and an operator; a fourth step of displaying plural images extracted by a search using the query formulation; a fifth step of selecting a desired image from the displayed images; and a sixth step of displaying the document linked to the selected image.

In the first step, the mapping between the document data and the index image data may be performed automatically, for electronic documents, by analyzing their code contents, while the mapping for image documents may be performed automatically by image processing. Specifically, when the document data is linked to the index image data contained in the document, the document may be formed of either electronic data (such as text codes in HTML format) or imaged data (such as an imaged document read by a scanner). In the former case, the text code can be analyzed to determine whether any index image data is contained and where it is stored. In the latter case, the image document can be processed to separate the same into a character image and index image data and to determine whether any index image data is contained and where it is stored.

In the second step, an image to match against index images of a document to be retrieved may be selected as key images by entering the image with the use of a scanner or camera employing a photo-electric element. Further, in the third-step, a query formulation may be formed by the steps of: displaying icons representing the key images and the icons representing the operators; and selecting elements to form the query formulation with the use of the displayed icons. This method makes it easy to form the query formulation.

According to the retrieval method of the present invention, not only images identical to the key image but also images relevant to the key image can be included in the objects to search. This enables effective search and retrieval.

Further, in the fourth step, the plural images extracted may be clustered and the clusters may be displayed. Thus, the searcher is allowed to visually obtain plural images at a time, which makes it easy to select a desired image from the images thus displayed. It is also possible to extract plural fearture vectors from the extracted images to cluster the images by the use of the distance of the feature vectors. Further, it is also preferable to display the extracted images in a space having axes of some of the feature vectors.

Another aspect of the present invention is a document retrieval method for retrieving a document containing images, and the method includes the steps of: mapping document data to index image data contained in the corresponding documents; selecting a specific image as a key image; extracting from the index image data plural images similar to the key image; displaying the plural images extracted; selecting a desired image from the displayed images; and displaying a document linked to the selected image.

Plural images may be selected as the key images. When images similar to one of the key images are extracted from the index image data for each of the key images, an image group formed of a plurality images can be extracted for each of the key images. It is also possible to display a logical sum or logical product of these groups.

A desired image may be displayed by displaying plural icons representing the key images and an icon representing a logical operator, combining the displayed icons to form a query formulation, and displaying images according to the query formulation. The operability can be improved by this method.

The icons for images may be formed by the images themselves, reduced images, or simplified symbols.

The icon for logical operator may be an icon indicating a logical product (“AND”), or an icon indicating a logical sum (“OR”). In some cases, other operators such as “NAND” and “NOR” may be used. A query formulation is formed by combining the displayed icons, and the query formulation is used to perform a set operation of the plural image groups extracted based on the plural key images. The result of the set operation is displayed as the plural images extracted. The plural images extracted may be displayed in a three-dimensional space according to the feature vectors of the images.

A document retrieval apparatus of the present invention is for retrieving a document containing an image, and the apparatus includes: a memory device for storing a correspondence relationship between document data and index image data contained in the document; a key image selecting device for selecting a specific image as a key image; a processing device for extracting, from the index image data, plural images similar to the key image; an image display device for displaying the plural images extracted; an image selecting device for selecting a desired image from the displayed images; and a document display device for displaying a document linked to the selected image. The memory device may be a hard disk or the like. The key image selecting device may be a scanner for reading a key image, or a pointing device for selecting one of images or icons displayed on a monitor screen.

The memory device may store at least a correspondence relationship between the document data and the index image data contained in the document, and need not necessarily store the document data itself or index image data itself. According to a preferred embodiment, the capacity of the memory device can be reduced by storing therein index image data (or processed index image data) serving as searching keys, while storing only a storage location (access destination such as address) for the document.

According to another aspect of the present invention, a document retrieval apparatus includes an input device, a display device, a processing device, and a memory device, wherein the memory device is a memory device for storing a correspondence relationship between document data and index image data contained in the document, and the processing device performs control so that a specific image is selected as a key image with the use of the input device, plural images similar to the key image are extracted from the memory device, the plural images extracted are displayed on the display device, a desired image is selected from the displayed images with the use of the input device, and a document corresponding to the selected image is displayed on the display device. The input device may be provided by a pointing device such as a mouse, a scanner, or a keyboard. The display device may be provided by one or more output devices such as displays or printers. The processing device may be provided by exclusive hardware, or software operating on a general purpose processor.

The apparatus according to the present invention may further include an interface for connecting the apparatus to a network. The interface allows the retrieval apparatus to access documents present on other memory devices connected to the network, to acquire addresses indicating the locations of the documents and index image data contained in the document, and to store the document addresses and the index image data, while mapping them to each other, in the memory device. This configuration makes it possible to use the Internet or the like as a search engine. In this case, the index images may be stored directly as they are, whereas the capacity of the memory device can be utilized more efficiently by compressing the index image data or simplifying the images.

In general, as exemplified by patent documents, the contents of documents are often expressed more explicitly by photographs, drawings, or tables contained therein. This is because, for the matters or parts of the documents which the authors want to emphasize, they tend to use images for appealing to the eyes of readers. In fact, it is rather difficult to find a recent document containing no images. Therefore, an optimal method to express the content of a document is to express the same with a set of images contained in the document. In the present invention, therefore, the content of a document is expressed by plural internal images to improve the retrieval success rate. Further, a group of images contained in the document retrieved with the use of these images is three-dimensionally displayed on a display screen. Thus, the search results can be provided in an at-a-glance fashion. The entry of a query formulation using one or more of the key images enables the searcher to conduct searches in a variety of searching conditions. Further, the method of the present invention can be combined with a conventional technique. For example, a text (keywords) may be included in the query formulation to enable the searcher to conduct searches using both images and keywords and to obtain more precise search results.

### BRIEF DESCRIPTION OF THE DRAWINGS

FIG. 1 is a diagram showing an example of configuration of a document retrieval apparatus according to an embodiment of the present invention and documents on a network to be searched through;

FIG. 2 is a flowchart illustrating an example of processing performed by the processing device 11 in FIG. 1;

FIG. 3 is a diagram showing a data relationship and data correspondence in the processing performed by the document retrieval apparatus 1;

FIG. 4 is a flowchart illustrating the processing steps for mapping documents to index images, performed by the processing device 11 in FIG. 1;

FIG. 5 is a flowchart illustrating the processing steps for presenting key images to be searched, performed by the processing device 11 in FIG. 1;

FIG. 6 is a flowchart illustrating the processing steps for making a query formulation with key images, performed by the processing device 11 in FIG. 1;

FIG. 7 is a diagram showing examples of windows displayed for selection of key images and query symbols and examples of query formulations, in relation to the processing steps for making the query formulation with key images performed by the processing device 11 in FIG. 1;

FIG. 8 is a flowchart illustrating the processing steps for displaying images retrieved based on similarity measurements, performed by the processing device 11 in FIG. 1; and

FIG. 9 is a flowchart illustrating the processing steps for selecting a specific image and displaying its corresponding document, performed by the processing device 11 in FIG. 1.

### DETAILED DESCRIPTION OF THE PREFERRED EMBODIMENTS

The present invention is embodied as searching software which operates on computers such as personal computers (PC). Specifically, a retrieval apparatus according to the present invention includes a computer such as a personal computer, a display device, a pointing device such as a mouse, an imaging device, and a memory device for storing images and documents. Documents to be retrieved include documents in files connected on a network, for example, websites on the Internet.

A preferred embodiment of the present invention will now be described in detail with reference to the attached drawings.

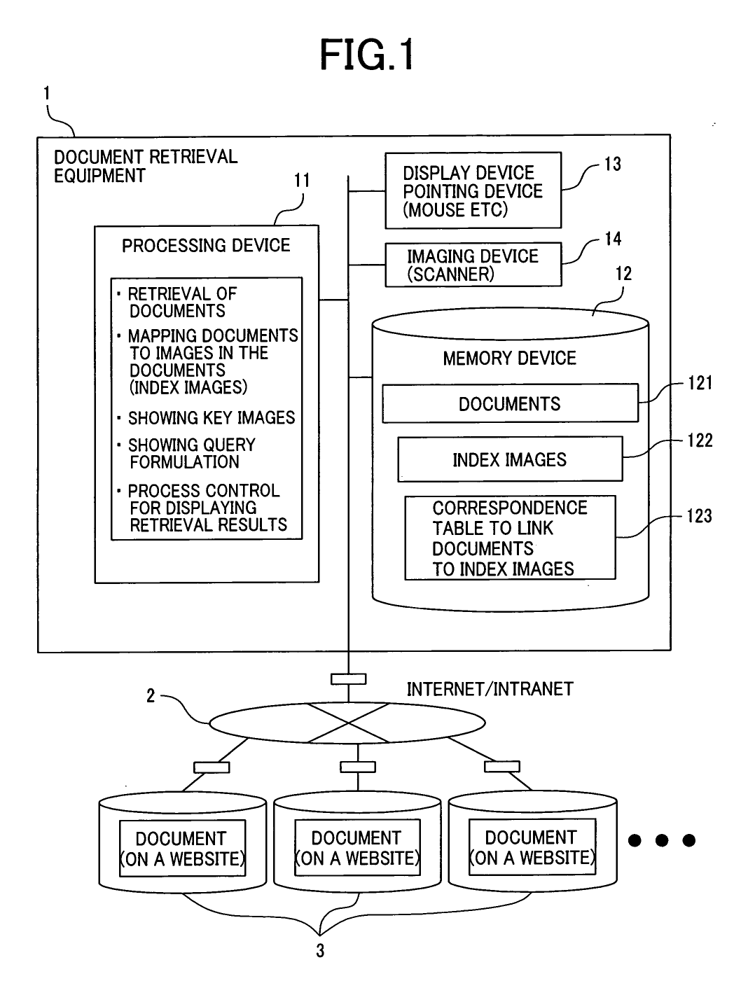

FIG. 1 shows an example of system configuration for document retrieval on the Internet according to the embodiment. A document retrieval apparatus 1 shown here is for executing a document retrieval method of the present invention, and includes a processing device 11, a memory device 12, a display device and pointing device (such as a mouse) 13, and an imaging device 14 such as a scanner. In this example, the document retrieval apparatus 1 is connected to Website documents 3 by means of the Internet or an intranet 2.

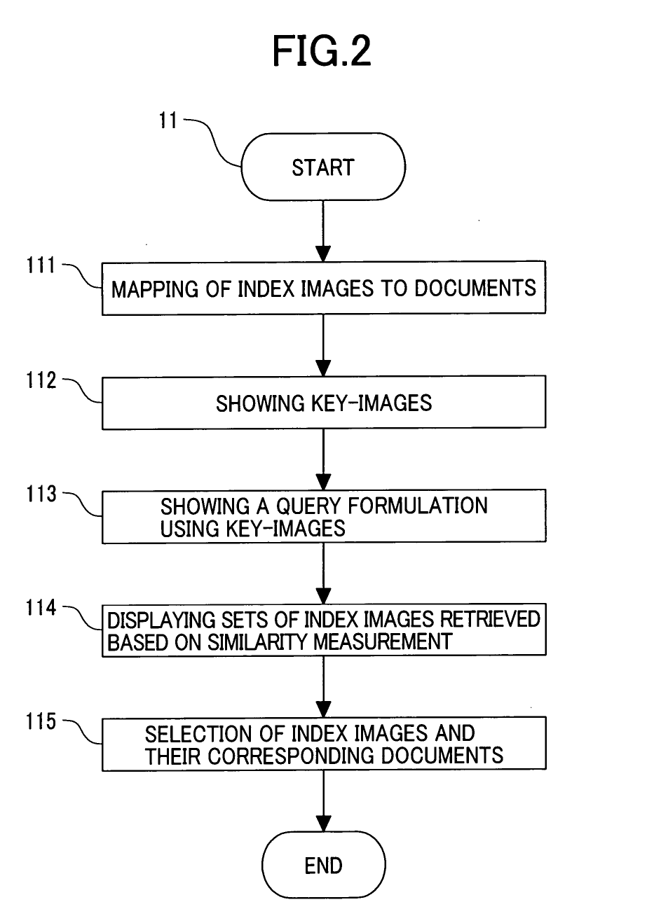

FIG. 2 is a flowchart illustrating particulars of the processing performed by the processing device 11 in FIG. 1.

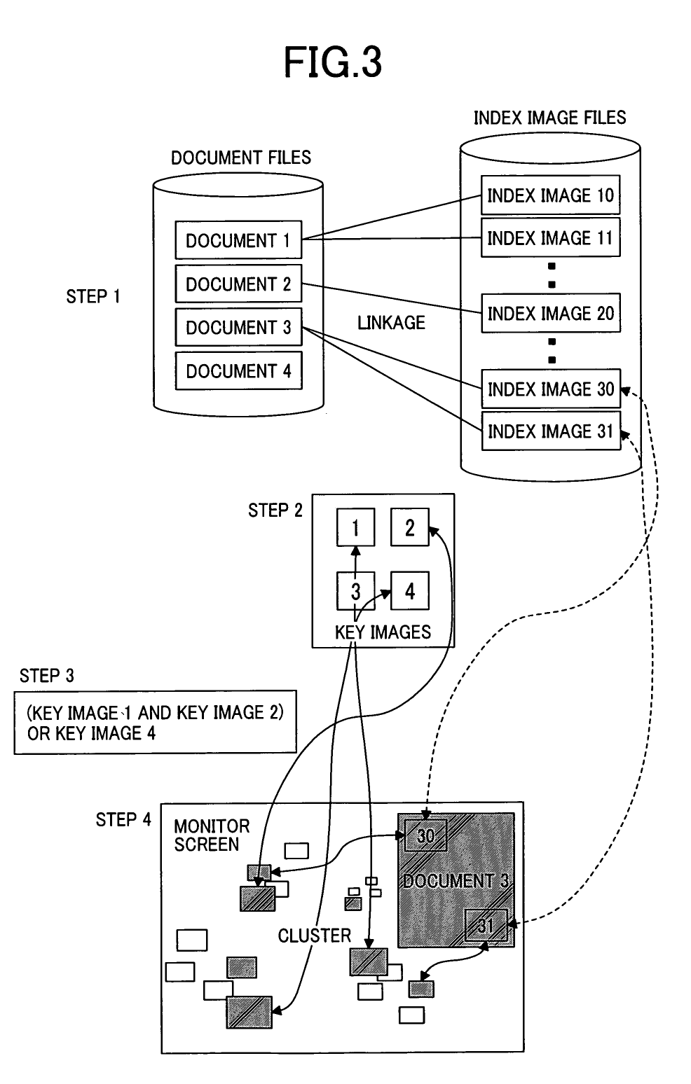

FIG. 3 is a conceptual diagram showing data relationship and data correspondence in the processing performed by the document retrieval apparatus.

The retrieval method according to the embodiment performs document retrieval in the following steps. The description will be made with reference to the FIGS. 2 and 3.

(1) A searching robot searches through documents on the network, extracts images (photographs, diagrams, tables and the like) from the documents, and maps the documents to the index image (step 111 in FIG. 2, and step 1 in FIG. 3). The results are stored in the memory device 12 in FIG. 1, as documents or document addresses (URLs for Website documents) 121, index images 122, and a correspondence table 123 linking these documents or document addresses to the index images.

The contents of the tables 123 are schematically shown in step 1 in FIG. 3. The documents retrieved by the search robot are stored in the document file. The index images contained in these documents are stored in the index image file. The table 123 is for linking the documents to the index images. For example, a document 1 is linked to index images 10 and 11, a document 2 is linked to an index image 20, and a document 3 is linked to index images 30 and 31. The search, storage and linkage by the search robot may be previously performed in any spare time or at a specific time.

(2) When retrieving a document, an image (key image) representing the content of the document to be retrieved is presented (step 112 in FIG. 2, and step 2 in FIG. 3). Such key image may be presented, for example, by entering the key image using the imaging device 14 such as a scanner, or by selecting the key image from existing electronic documents.

The step 2 in FIG. 3 shows a case where four key images are presented.

(3) Subsequently, a query formulation using the key images is entered (step 113 in FIG. 2, and step 3 in FIG. 3). For example, when retrieving a document having both an image similar to a key image 1 and an image similar to a key image 2, or a document having no such images but having an image similar to a key image 4, the query formulation is made as shown in the step 3 in FIG. 3.

(4) The index images in the memory device 12 are first searched through according to this query formulation. For the example shown in FIG. 3, all of the addresses of the documents containing an image similar to the key image 1 and the addresses of the documents containing an image similar to the key image 2 are extracted to find the addresses present in both of the document groups. Additionally, the addresses of the documents containing an image similar to the key image 4 are also extracted and added to the retrieved addresses.

(5) Subsequently, for each of the documents corresponding to the retrieved document addresses, index images similar to the key image 1, index images similar to the key image 2, and index images similar to the key image 4 are extracted from the memory device 12, and displayed in clusters by the display device 13 in a three-dimensional space with an axis of sequentially varying image features (step 114 in FIG. 2, and step 4 in FIG. 3). The extraction of similar images can be performed for example by a technique described in Japanese Patent Laid-Open Publication No. 2000-029885. The display thereof can be performed by a known method such as those described in Japanese Patent Laid-Open publication No. H10-193838 titled “Image Retrieval Method and Apparatus”, and A. Hiroike, Y. Musha, A. Sugimoto and Y. Mori, “Visualization of Information Spaces to Retrieve and Browse Image Data”, Proc. Visual 99, Springer-Verlag, 155-162, 1999. It is made possible, by searching and displaying with these methods, to provide at-a-glance search results. The step 4 in FIG. 3 shows a monitor screen displaying the search results thus obtained.

(6) When the searcher observes the images displayed on the screen and selects a desired one with the pointing device 13 such as a mouse, a document containing the selected image is displayed on the display device by referring to the correspondence table stored in the memory device 12. Thus, the searcher is allowed to examine the contents of the document (step 115 in FIG. 2). An example of such document is shown in the upper right on the screen shown in step 4 in FIG. 3.

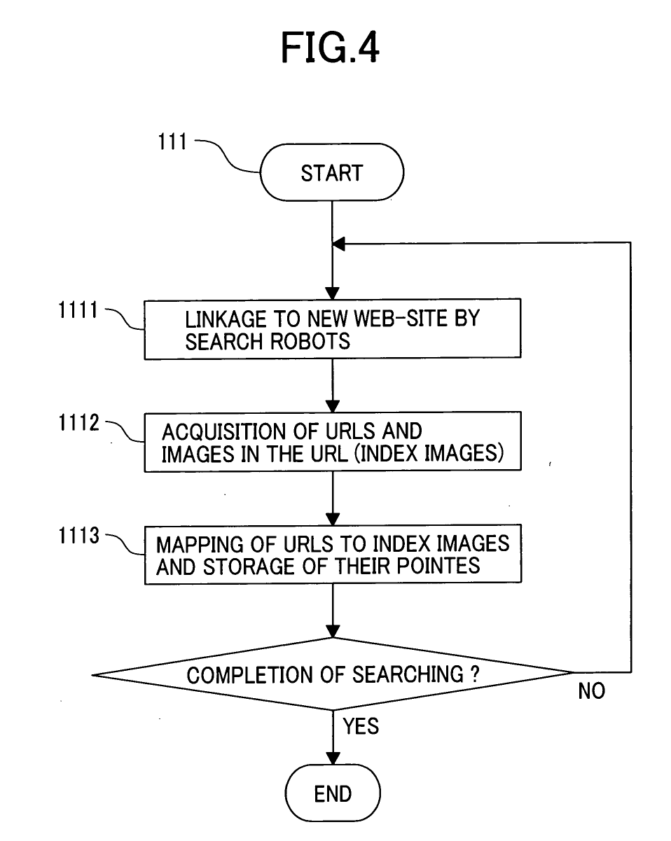

These are the brief descriptions of the procedures of the retrieval method according to the embodiment of the present invention. Description will now be made of particulars of the processing performed in each step, with reference to FIGS. 4 to 9.

FIG. 4 shows an example of the processing of step 111 in FIG. 2 to map documents to index images. In step 1111, a conventional searching robot is used to search Web sites. In step 1112, URLs of home page documents as shown as documents 3 in FIG. 1 are acquired while, at the same time, images contained in these documents are acquired. In step 1113, the retrieved URLs, the index images, and their correspondence relationship are recorded in the respective storage areas in the memory device 12 in FIG. 1, that is, in the storage areas for the document addresses, the index images, and the correspondence table linking the document addresses to the index images. The documents on the network are sequentially searched until there is no more document to search. This processing may be previously performed in any spare time or at a specific time.

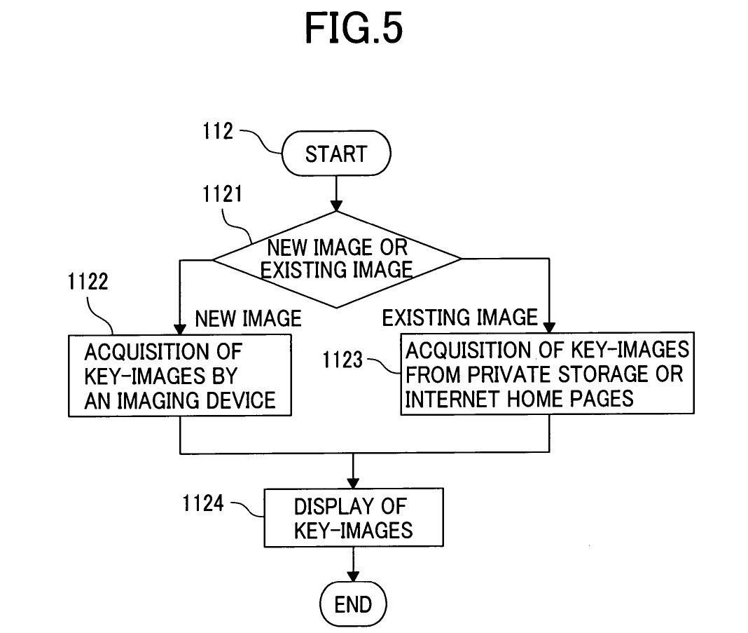

FIG. 5 shows an example of the processing of step 112 in FIG. 2 to present key images to be searched. In step 1121, it is first determined whether key images are newly entered with a scanner or existing electronic images are used. If key images are to be entered with a scanner, the imaging device 14 in FIG. 1 is used to acquire key images. If existing electronic images are to be used, key images are selected from the network or the storage medium in the computer. In step 1124, the selected key images are displayed by the display device 13 in FIG. 1 as icons representing the key images.

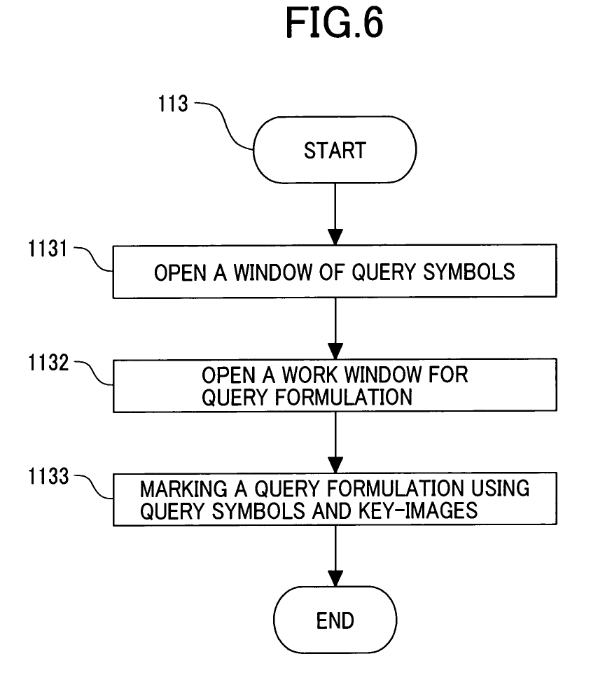

FIG. 6 shows an example of the processing 113 in FIG. 2 to enter a query formulation using the key images. This processing is composed of three steps. In the first step 1131, a tool box window of query symbols is opened.

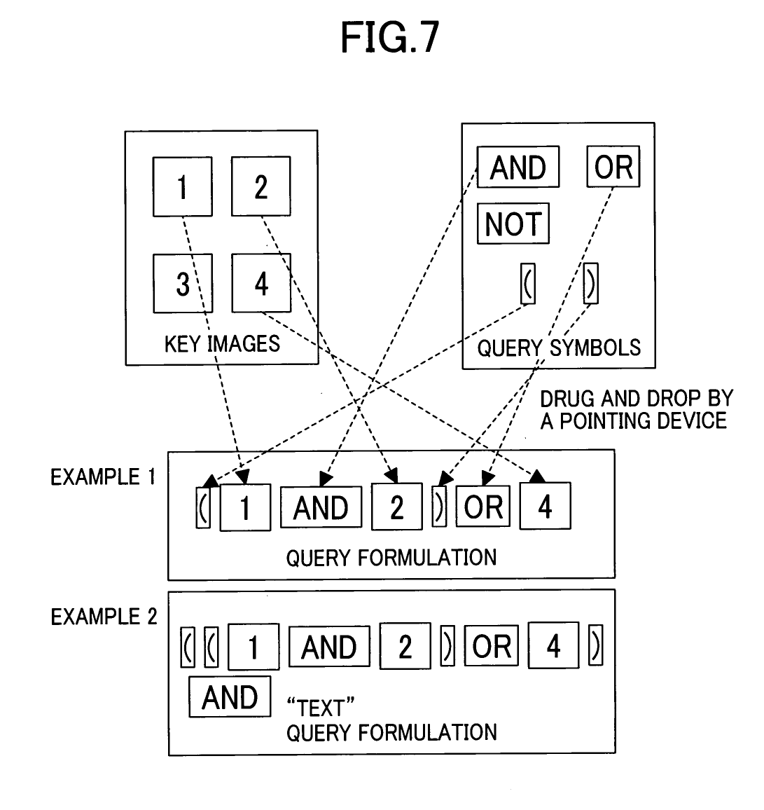

FIG. 7 shows an example of a window for selecting key images and a window for selecting query symbols, and examples of query formulations.

A tool box window displays query symbol icons as shown in the upper right of FIG. 7. In step 1132, a work window is opened for forming a query formulation. In step 1124 described above, the icons of the key images are displayed as shown in the upper left of FIG. 7. In step 1133, an existing graphical user interface (GUI) in the computer is used to form a query formulation. For example, as shown in Example 1 of the central drawing in FIG. 7, a query formulation is formed by selecting query symbols, parentheses and key images from the respective windows, and drugging and dropping them sequentially into the work window shown in the lower part in FIG. 7. Example 1 shows a query formulation formed to read as “(key image 1 AND key image 2) OR key image 4”. Example 2 shows an example of query formulation which is able to further include a text code of keywords.

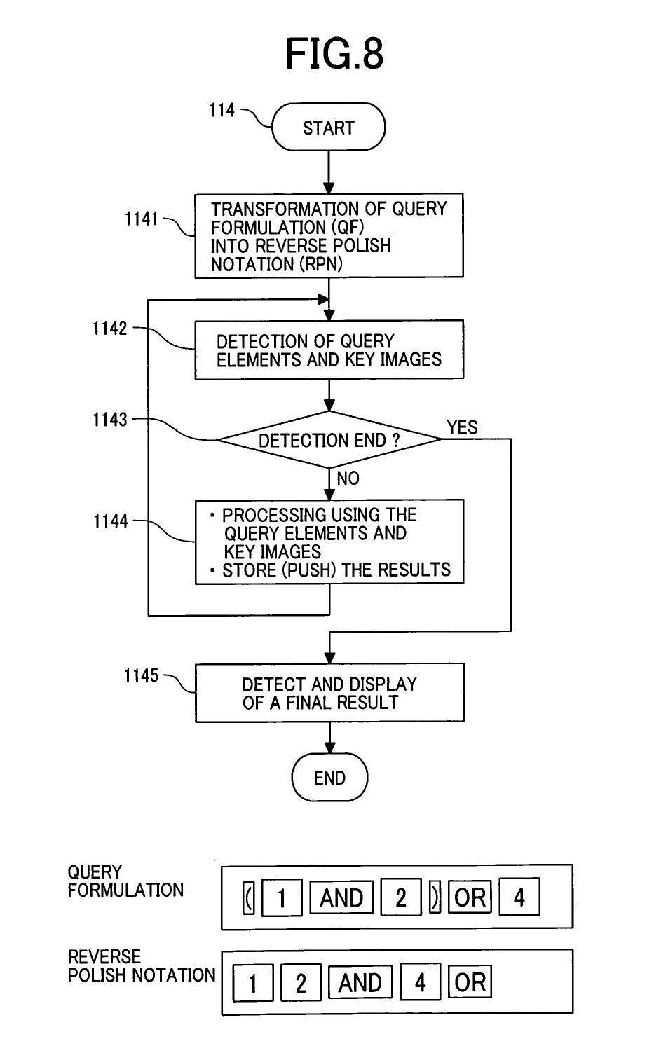

FIG. 8 shows an example of the processing of step 114 in FIG. 2 to perform similarity-based retrieval of images similar to the key images based on the query formulation. The query formulation is first converted into reverse Polish notation which is used for arithmetical operations in an electronic calculator or the like. Specifically, in step 1141 in FIG. 8, the query formulation is converted into the reverse Polish notation in which the operands and operators are placed in the order of processing (arranged in sets each made up of a query element (query symbol) placed after a data string). These data are stored in a temporary memory unit in the processing device 11 in a linear fashion. In step 1142, the first set (in this example, the set of the key images 1 and 2 and the query symbol “AND”) is popped. If there are no elements to be popped in step 1143, the execution of the query formulation is terminated. If there are elements, processing corresponding to the first set (in this example, the set of the key images 1 and 2 and the query symbol “AND”) is performed in step 1144. In this example, as described before, all the document addresses of the documents containing an image similar to the key image 1 and of the documents containing an image similar to the key image 2 are extracted. The addresses commonly present in both of these address groups are found and stored (pushed) as data group A.

Subsequently, the second set (in this example, the set of the document address group A thus pushed, the key image 4, and the query symbol “OR”) is popped. This time in step 1144, all the document addresses of documents containing an image similar to the key image 4 are added (ORed) to the document address group A. A document address group B thus obtained is stored (pushed). In this example, all the sets have been done by this. In step 1145, the document address group B is popped, and all the images similar to the key images 1, 2 and 4 in the documents of the document address group B are displayed. The similarity measurement between the images is computed for example by a method of obtaining various fearture vectors of the images and determining the similarity measurement based on the distance of these fearture vectors. The images are displayed, as described before, by the method of three-dimensionally displaying the image while sequentially selecting the axes of fearture vectors, as disclosed in JP H10-193838A titled “Image Retrieval Method and Apparatus”. This makes it possible to display the retrieved images in an at-a-glance fashion.

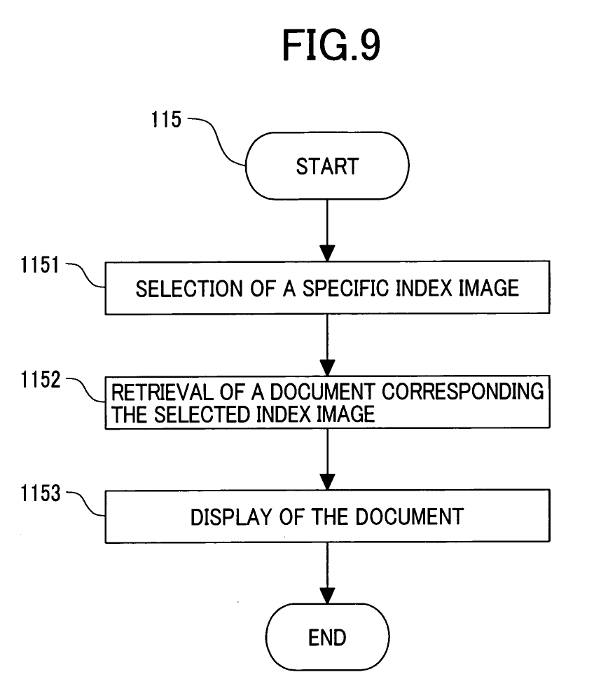

FIG. 9 shows an example of the processing of step 115 in FIG. 2 to select specific index images and to display documents corresponding thereto. In step 1151, the searcher selects specific images of his/her interest from among the images three-dimensionally displayed by the display device 13 in step 1145. In step 1152, the documents corresponding to the selected images are retrieved with reference to the correspondence table linking documents to index images. In step 1153, the corresponding documents are displayed by the display device 13. The document retrieval apparatus can be embodied completely in a manner as described above.

The description above has been made in terms of an example of searching with the use of index images representing and contained in documents. It should be understood, however, that this may be combined with a conventional searching method using keywords. In this case, as shown in Example 2 in FIG. 7, a text code formed of keywords may be included in a query formulation. For implementing this searching method, advance preparation is of course necessary. Specifically, a searching robot is used to search through documents while finding keywords in the documents, and to record document addresses and keywords thus found and a correspondence table linking them in the memory device 11.

It is to be understood that the present invention is not limited in its application to the embodiments described above, and the invention is capable of being practiced or carried out in various ways. For example, the retrieval method and apparatus of the present invention are not limited in their application to search Website documents on the Internet, but they are also applicable to search document files in a computer.

As described above, the present invention is capable of improving the retrieval success rate by representing documents with index images contained therein and using these index images to retrieve documents. The present invention is also capable of providing search results in an at-a-glance fashion by three-dimensionally displaying, on a display screen, the images contained in the documents retrieved with the use of these index images. Further, the entry of a query formulation using one or more key images enables the searcher to conduct searches in a variety searching conditions. Therefore, the present invention, which is applicable to search through Website documents on the Internet and document files in a computer, makes a great contribution to improve the efficiency of the document retrieval.

What is claim is:

1. A document retrieval method for retrieving a document containing an image, the method comprising:
a first step of mapping document data to index image data contained in the corresponding documents;
a second step of selecting at least one specific image as a key image;
a third step of forming a query formulation with the use of the selected key image and at least one operator;
a fourth step of displaying a plurality of images extracted by a search using the query formulation;
a fifth step of selecting a desired image from the displayed images; and
a sixth step of displaying a document linked to the selected image.

2. The document retrieval method according to claim 1, wherein, in the first step, the mapping between the data document and the index image data is performed automatically, for electronic documents, by analyzing their code contents, while the mapping for image documents is performed automatically by processing the images.

3. The document retrieval method according to claim 1, wherein, in the second step, an image to match against index images of a document to be retrieved may be selected as a key image by entering the image with the use of a scanner or camera employing a photo-electric element.

4. The document retrieval method according to claim 1, wherein the third step comprises the steps of:
displaying an icon representing each of the key image and an icon representing each of the operators; and
selecting elements to form the query formulation with the use of the displayed icons.

5. The document retrieval method according to claim 1, wherein, in the fourth step, objects of the search using the query formulation include images similar to the key image.

6. The document retrieval method according to claim 1, wherein, in the fourth step, the plurality of images extracted are clustered and the clusters are displayed.

7. The document retrieval method according to claim 1, wherein, in the fourth step, a plurality of fearture vectors are obtained from the extracted images, and the images are clustered based on a distance of the fearture vectors.

8. The document retrieval method according to claim 7, wherein the extracted images are displayed in a space having axes of some of the plurality of fearture vectors.

9. A document retrieval method for retrieving a document containing an image, the method comprising the steps of:
mapping document data to index image data contained in the corresponding documents;
selecting specific images as key images;
extracting from the index image data a plurality of images similar to the key image;
displaying the plurality of images extracted;
selecting a desired image from the displayed images; and
displaying a document linked to the selected image.

10. The document retrieval method according to claim 9, comprising:
selecting a plurality of images as the key images;
extracting, from the index image data, images similar to each of the plurality of images selected as the key images; and
displaying a logical sum or logical product of a set of the images extracted based on each of the key images, as at least a part of the plurality of images extracted.

11. The document retrieval method according to claim 9, comprising:
selecting a plurality of images as the key images;
displaying icons representing the plurality of key images and icons representing logical operators;
combining the displayed icons to form a query formulation; and
displaying at least one of the plurality of images extracted based on the plurality of key images according to the query formulation, as the extracted image(s).

12. The document retrieval method according to claim 9, comprising:
selecting a plurality of images as the key images;
displaying at least icons representing the plurality of key images, an icon representing a logical product, and an icon representing a logical sum;
combining the displayed icons to form a query formulation;
performing a set operation of the plurality of images extracted based on the plurality of key image, according to the query formulation; and
displaying a result of the set operation as the plurality of images extracted.

13. The document retrieval method according to claim 9, wherein the plurality of extracted images are displayed in a three-dimensional space according to fearture vectors of the images.

14. A document retrieval apparatus for retrieving a document containing an image, comprising:
a memory device for storing a correspondence relationship between document data and index image data contained in the document;
a key image selecting device for selecting a specific image as a key image;
a processing device for extracting, from the index image data, a plurality of images similar to the key image;
an image display device for displaying the plurality of images extracted;
an image selecting device for selecting a desired image from the displayed images; and
a document display device for displaying a document linked to the selected image.

15. The document retrieval apparatus according to claim 14, wherein the key image selecting device is a scanner for reading a key image, or a pointer for selecting an image or an icon thereof displayed on a monitor screen.

16. A document retrieval apparatus comprising an input device, a display device, a processing device, and a memory device, wherein:
the memory device is a memory device for storing a correspondence relationship between document data and index image data contained in the document; and
the processing device performs control so that a specific image is selected as a key image with the use of the input device, a plurality of images similar to the key image are extracted from the memory device, the plurality of images extracted are displayed on the display device, a desired image is selected from the displayed images with the use of the input device, and a document corresponding to the selected image is displayed on the display device.

17. The document retrieval apparatus according to claim 16, further comprising an interface for connecting the retrieval apparatus to a network, the interface allowing the retrieval apparatus to access documents present on other memory devices connected to the network, to acquire addresses indicating locations of the documents and index image data contained in the documents, and to store the document addresses and the index image data, while mapping them to each other, in the memory device.

18. The document retrieval apparatus according to claim 16, wherein the processing device performs control so that a plurality of images are selected as the key images, at least icons representing the key images, an icon representing a logical product, and an icon representing a logical sum are displayed on the display device, the displayed icons are combined to form a query formulation, and a set of a plurality of groups of images extracted based on each of the key image is extracted according to the query formulation.

19. A document retrieval program for retrieving a document, the program operating on a processing device of a system comprising, an input device, a display device, the processing device and memory device, the program comprising the functions of:
storing, in the memory device, a correspondence relationship between document data and index image data contained in the document:
allowing a searcher to select a specific image as a key image with the use of the input device;
extracting a plurality of images similar to the key image from the memory device;
displaying the extracted images on the display device;
allowing the searcher to select a desired image from the images displayed on the imaging device; and
displaying a document linked to the selected image on the display device.
